(19) United States
(12) Patent Application Publication
(10) Pub. No.: US 2013/0177163 A1
(43) Pub. Date: Jul. 11, 2013

(54) NOISE REDUCTION USING A SPEAKER AS A MICROPHONE

(71) Applicant: Richtek Technology Corporation, Chupei City (TW)

(72) Inventor: Ming-Jun HSIAO, Zhubei City (TW)

(73) Assignee: RICHTEK TECHNOLOGY CORPORATION, Chupei City (TW)

(21) Appl. No.: 13/734,508

(22) Filed: Jan. 4, 2013

(30) Foreign Application Priority Data
Jan. 5, 2012 (TW) 101100482

(51) Int. Cl. G10K 11/16

(52) U.S. Cl. CPC G10K 11/16
USPC 381/71.1

(57) ABSTRACT

During sound recording by a microphone, a recording device and method locate characteristics of noise by using a speaker as a second microphone to simultaneously receive sound, and then use the characteristics of noise for noise reduction of the received sound by the microphone, thereby improving the quality of sound recording. By using the speaker as a microphone to establish a microphone array with the existing microphone for noise reduction, no costs of additional microphones is required.

### FIELD OF THE INVENTION

The present invention is related generally to a recording device and, more particularly, to circuit and method for noise reduction of a recording device.

### BACKGROUND OF THE INVENTION

Wind noise and other ambient noise are usually troublesome for a sound recording device such as a digital video camera and a recording pen. Using a specific algorithm or filter to locate the characteristics of noise and remove it from original sound requires a lot of computing power and corresponding hardware cost. Using a microphone array (two or more microphones), for example, U.S. Pat. Nos. 7,174,023 and 7,895,036 and U.S. Pat. Publication No. 2009/0002498, can achieve better results but the cost of additional microphones is still an issue.

In the field of communications, on the other hand, U.S. Pat. Publication No. 2011/0181452 teaches using a speaker at the far end that is communicating with the user of a communication device at the near end as a microphone for microphone array noise reduction of the sound transmitted to the far end. However, this art adopts a speaker as a microphone for a communication device to perform acoustic echo cancellation/suppression or level adjustment, but is not dedicated to enhance the quality of sound recording.

Therefore, it is desired circuit and method for noise reduction of a recording device without using additional microphones.

### SUMMARY OF THE INVENTION

An objective of the present invention is to provide a low noise recording device and a noise reduction method thereof.

Another objective of the present invention is to provide a recording device and method using a speaker as a microphone for noise reduction.

According to the present invention, during sound recording by a microphone, a recording device and method locate characteristics of noise by using a speaker as a second microphone to simultaneously receive sound, and then use the characteristics of noise for noise reduction of the received sound by the microphone, thereby improving the quality of sound recording.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a circuit diagram of a first embodiment according to the present invention; and

FIG. 2 is a circuit diagram of a second embodiment according to the present invention.

### DETAILED DESCRIPTION OF THE INVENTION

Since a recording device already has a microphone for receiving sound and a speaker for playing sound, using the speaker as a second microphone to characterize noise requires no additional microphones. Specifically, using the existing speaker of a recording device as a second microphone to establish a microphone array with the existing microphone of the recording device for noise reduction of the recording device needs no costs of additional microphones.

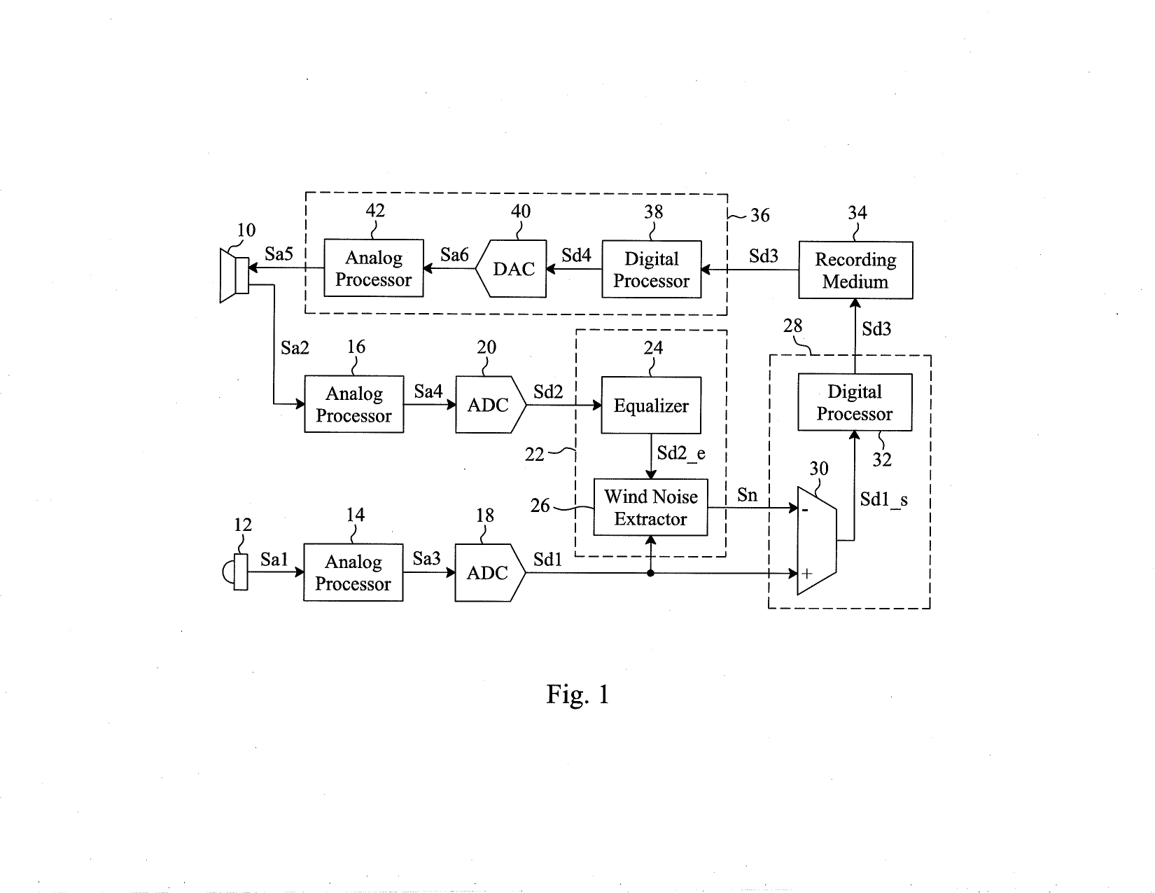

FIG. 1 is a recording device according to the present invention, which includes a speaker 10, a microphone 12, analog processors 14 and 16, analogy-to-digital converters (ADCs) 18 and 20, a noise detector 22, a noise processor 28, a recording medium 34 and a play circuit 36. During sound recording, the microphone 12 receives sound to generate an analog signal Sa1, meanwhile the speaker 10 acts as another microphone that also receives the sound to generate an analog signal Sa2. The analog processors 14 and 16 process the analog signals Sa1 and Sa2, to generate analog signals Sa3 and Sa4, respectively. The signal processing applied to the analog signals Sa1 and Sa2 by the analog processors 14 and 16 may include amplification, modulation or gain adjustment. The ADCs 18 and 20 convert the analog signals Sa3 and Sa4 into digital signals Sd1 and Sd2, respectively. The noise detector 22 includes an equalizer 24 and a wind noise extractor 26. The equalizer 24 adjusts the frequency response of the digital signal Sd2 to generate a digital signal Sd2_e having a frequency response identical to that of the digital signal Sd1. The wind noise extractor 26 receives the digital signals Sd1 and Sd2_e, and locates the characteristics of noise from the digital signal Sd1 by using the digital signal Sd2_e to generate a digital signal Sn representative of the characteristics of noise. The noise processor 28 includes a subtractor 30 and a digital processor 32. The subtractor 30 receives the digital signals Sd1 and Sn, and subtracts Sn from Sd1 to generate a digital signal Sd1_s. Then, the digital processor 32 processes the digital signal Sd1_s to generate a digital signal Sd3. The signal processing applied to the digital signal Sd1_s by the digital processor 32 may include sound optimization and background noise removal. The recording medium 34 stores the digital signal Sd3. When the recording device is to play the recorded sound, the play circuit 36 obtains the digital signal Sd3 from the recording medium 34 to generate an analog signal Sa5 for driving the speaker 10 to play sound. The play circuit 36 has a digital processor 38, a digital-to-analogy converter (DAC) 40 and an analog processor 42. The digital processor 38 processes the digital signal Sd3 to generate a digital signal Sd4. The signal processing applied to the digital signal Sd3 by the digital processor 38 may include volume adjustment. The DAC 40 converts the digital signal Sd4 into an analog signal Sa6. The analog processor 42 processes the analog signal Sa6 to generate an analog signal Sa5. The analog processor 42 functions like the analog processors 14 and 16.

Analog processors and digital processors for applying signal processing to sound in a recording device or a communication system are well known, for example, as mentioned in U.S. Pat. Publication No. 2011/0181452. Circuit and operation of a wind noise extractor may also refer to U.S. Pat. Nos. 7,174,023 and 7,895,036 and U.S. Pat. Publication No. 2009/0002498 for details. Thus, the circuits and operation of the analog processors 14, 16 and 42, the digital processors 32 and 38, and the wind noise extractor 26 are not described herein.

Since major energy of wind noise is located as low frequency, a speaker as a microphone is enough to characterize it, and eliminates the requirement of additional microphones. Likewise, it may also use a speaker as a microphone to pick up other acoustic or mechanical noise and reduce those noise in other applications. For example, a speaker can be adopted to receive motor noise of lens module of a digital video camera or other collision noise occurred at recording device itself.

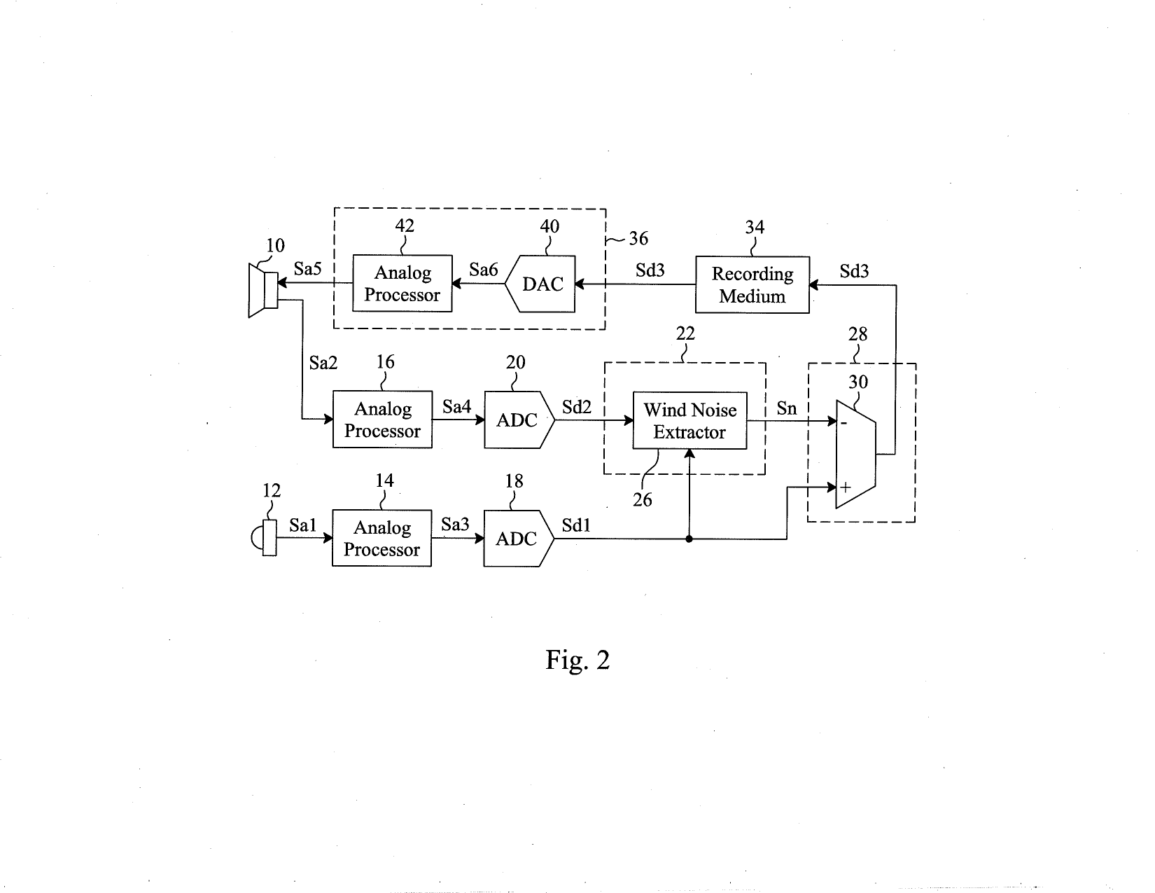

In some applications, the equalizer 24 and the digital processors 32 and 38 shown in FIG. 1 may be omitted in some applications, as shown in FIG. 2. In this embodiment, the noise detector 22 does not include an equalizer, and the wind noise extractor 26 directly uses the digital signals Sd1 and Sd2 to locate characteristics of noise to generate the digital signal Sn. The noise processor 28 does not further apply digital signal processing to the output of the subtractor 30 that subtracts Sn from Sd1, and directly sends it to the recording medium 34. Likewise, the play circuit 36 does not further apply digital signal processing to the digital signal Sd3 before converting it into the analog signal Sa6.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A low noise recording device, comprising:
a microphone and a speaker configured to simultaneously receive sound during sound recording to generate a first analog signal and a second analog signal, respectively;
a first analog processor connected to the microphone, configured to process the first analog signal to generate a third analog signal;
a first analog-to-digital converter connected to the first analog processor, configured to convert the third analog signal into a first digital signal;
a second analog processor connected to the speaker, configured to process the second analog signal to generate a fourth analog signal;
a second analog-to-digital converter connected to the second analog processor, configured to convert the fourth analog signal into a second digital signal;
a noise detector connected to the first analog-to-digital converter and the second analog-to-digital converter, configured to use the first digital signal and the second digital signal to locate characteristics of noise;
a noise processor connected to the first analog-to-digital converter and the noise detector, configured to use the characteristics of noise for noise reduction of the first digital signal to generate a third digital signal; and
a recording medium connected to the noise processor, configured to store the third digital signal.

2. The low noise recording device of claim 1, wherein the noise detector comprises:
an equalizer connected to the second analog-to-digital converter, configured to adjust a frequency response of the second digital signal to generate a fourth digital signal having a frequency response identical to a frequency response of the first digital signal; and
a wind noise extractor connected to the first analog-to-digital converter and the equalizer, configured to receive the first digital signal and the fourth digital signal, and to locate the characteristics of noise from the first digital signal by using the fourth digital signal.

3. The low noise recording device of claim 1, wherein the noise detector comprises a wind noise extractor connected to the first analog-to-digital converter and the second analog-to-digital converter, configured to receive the first digital signal and the second digital signal, and to locate the characteristics of noise from the first digital signal by using the second digital signal.

4. The low noise recording device of claim 1, wherein the noise processor comprises:
a subtractor connected to the first analog-to-digital converter and the noise detector, configured to subtract the characteristics of noise from the first digital signal to generate a fourth digital signal; and
a digital processor connected to the subtractor, configured to process the fourth digital signal to generate the third digital signal.

5. The low noise recording device of claim 1, wherein the noise processor comprises a subtractor connected to the first analog-to-digital converter and the noise detector, configured to subtract the characteristics of noise from the first digital signal to generate the third digital signal.

6. The low noise recording device of claim 1, further comprising a play circuit connected to the recording medium and the speaker, configured to generate a fifth analog signal according to the third digital signal stored in the recording medium to drive the speaker for sound playing.

7. The low noise recording device of claim 6, wherein the play circuit comprises:
a digital processor connected to the recording medium, configured to process the third digital signal stored in the recording medium to generate a fourth digital signal;
a digital-to-analog converter connected to the digital processor, configured to convert the fourth digital signal into a sixth analog signal; and
a third analog processor connected to the digital-to-analog converter, configured to process the sixth analog signal to generate the fifth analog signal.

8. The low noise recording device of claim 6, wherein the play circuit comprises:
a digital-to-analog converter connected to the recording medium, configured to convert the third digital signal stored in the recording medium into a sixth analog signal; and
a third analog processor connected to the digital-to-analog converter, configured to process the sixth analog signal to generate the fifth analog signal.

9. A noise reduction method for a recording device including a microphone and a speaker, the noise reduction method comprising:
A.) simultaneously receiving sound by the microphone and the speaker during sound recording to generate a first analog signal and a second analog signal;
B.) applying analog signal processing to the first analog signal and the second analog signal to generate a third analog signal and a fourth analog signal, respectively;
C.) converting the third analog signal and the fourth analog signal into a first digital signal and a second digital signal, respectively;
D.) using the first digital signal and the second digital signal to locate characteristics of noise;
E.) using the characteristics of noise for noise reduction of the first digital signal to generate a third digital signal; and
F.) storing the third digital signal.

10. The noise reduction method of claim 9, wherein the step D comprises:
adjusting a frequency response of the second digital signal to generate a fourth digital signal having a frequency response identical to a frequency response of the first digital signal; and
locating the characteristics of noise from the first digital signal by using the fourth digital signal.

11. The noise reduction method of claim 9, wherein the step E comprises:
subtracting the characteristics of noise from the first digital signal to generate a fourth digital signal; and
applying digital signal processing to the fourth digital signal to generate the third digital signal.

12. The noise reduction method of claim 9, wherein the step E comprises subtracting the characteristics of noise from the first digital signal to generate the third digital signal.

13. The noise reduction method of claim 9, further comprising generating a fifth analog signal according to the third digital signal stored in the recording medium to drive the speaker for sound playing.

14. The noise reduction method of claim 9, further comprising:
applying digital signal processing to the third digital signal stored in the recording medium to generate a fourth digital signal;
converting the fourth digital signal into a fifth analog signal; and
processing the fifth analog signal to generate a sixth analog signal to drive the speaker for sound playing.

15. The noise reduction method of claim 9, further comprising:
converting the third digital signal stored in the recording medium into a fifth analog signal; and
processing the fifth analog signal to generate a sixth analog signal to drive the speaker for sound playing.
